(19) United States
(12) Patent Application Publication
(10) Pub. No.: US 2024/0316526 A1
(43) Pub. Date: Sep. 26, 2024

(54) PHOTOCATALYTIC HYDROGEN PEROXIDE PRODUCTION IN A DUAL OPTICAL FIBER-MEMBRANE SYSTEM

(71) Applicants: Yen-Jung Lai, Chandler, AZ (US); Paul K. Westerhoff, Scottsdale, AZ (US); Bruce E. Rittmann, Tempe, AZ (US); Tzu-Heng Wang, Tainan City (TW)

(72) Inventors: Yen-Jung Lai, Chandler, AZ (US); Paul K. Westerhoff, Scottsdale, AZ (US); Bruce E. Rittmann, Tempe, AZ (US); Tzu-Heng Wang, Tainan City (TW)

(21) Appl. No.: 18/614,054

(22) Filed: Mar. 22, 2024

Related U.S. Application Data
(60) Provisional application No. 63/492,054, filed on Mar. 24, 2023.
(60) Provisional application No. 63/455,240, filed on Mar. 28, 2023.

(51) Int. Cl. B01J 19/12; B01J 31/16; B01J 35/39; C01B 15/027

(52) U.S. Cl. CPC B01J 19/127; B01J 31/1691; B01J 35/39; C01B 15/027; B01J 2219/0869; B01J 2219/0877; B01J 2219/0892; B01J 2219/1203; B01J 2231/005; B01J 2531/842

(57) ABSTRACT

A photocatalytic reactor includes a polymeric side-emitting optical fiber having a coating with a photocatalyst embedded in a porous polymer, a light source optically coupled to the polymeric side-emitting optical fiber and configured to irradiate the photocatalyst, and a multiplicity of oxygen-permeable hollow-fiber membranes. The polymeric side-emitting optical fiber and the multiplicity of oxygen-permeable hollow-fiber membranes are configured to be at least partially immersed in water. When at least partially immersed in water, the multiplicity of oxygen-permeable hollow-fiber membranes is configured to provide dissolved molecular oxygen to the water, and the coating is configured to allow diffusion of the dissolved molecular oxygen into the coating and to allow diffusion of hydrogen peroxide out of the coating.

### CROSS-REFERENCE TO RELATED APPLICATION

This application claims the benefit of U.S. Patent Application No. 63/492,054 filed on Mar. 24, 2023, and U.S. Patent Application No. 63/455,240 filed on Mar. 28, 2023, both of which are incorporated herein by reference in their entirety.

### STATEMENT OF GOVERNMENT SUPPORT

This invention was made with government support under grant number 1449500 awarded by the National Science Foundation. The government has certain rights in the invention.

### TECHNICAL FIELD

This invention relates to systems and methods of making hydrogen peroxide using hollow-fiber membranes to deliver dissolved oxygen to visible-light side-emitting optical fibers coated with photocatalysts.

### BACKGROUND

Hydrogen peroxide (H₂O₂) is widely used for industrial synthesis of organic chemicals, oxidation of drinking or wastewater, and surface disinfection of pathogens. H₂O₂ production typically employs an energy- and chemical-intensive anthraquinone-oxidation process, which involves hydrogenation on a palladium catalyst while bubbling air through the solution. Anthraquinone is used in successive cycles after H₂O₂ extraction from solution. The process relies upon platinum group metals and produces potentially toxic waste streams.

### SUMMARY

This disclosure relates to systems and methods for the production of hydrogen peroxide (H₂O₂) using hollow-fiber gas-permeable membranes submerged in water to efficiently deliver dissolved oxygen to into water wherein polymeric optical fibers coated with a photocatalyst (e.g., stable metal organic framework) enmeshed within a porous cladding. Pressurized with air or pure oxygen, the hollow-fiber gas permeable membrane controls delivery of molecular oxygen into the water without forming bubbles. The oxygen saturation in solution is controlled by the partial pressure of oxygen in the pressurized gas. The side-emitting optical fiber delivers light (UV-A or visible wavelengths) to the photocatalyst embedded in a porous cladding of the polymeric optical fiber for the photogeneration of electrons and holes that react with the dissolved oxygen and water, respectively, to yield hydrogen peroxide. The photocatalyst is dispersed in cladding at least partially covering the exterior of the coated polymeric optical fiber. The optimal wavelengths to produce photogeneration can be tuned to selection of wavelengths of light, which is launched into a single optical fiber or a bundle of optical fibers using an artificial light source of concentrated solar light. For example, a metal organic framework (MOF) photocatalyst that includes a molecular moiety that adsorbs molecular oxygen near the MOF surface is active in the visible region of the light spectrum. The hollow-fiber membranes deliver dissolved oxygen into water with approximately 100% efficiency wherein it reacts on the photocatalyst coated optical fiber to generate H₂O₂.

With O₂ delivered from the hollow-fiber membranes and visible-light irradiation of the coated optical fiber, the H₂O₂-production rate in pure water was as high as 290 mM h⁻¹ catalyst-g⁻¹. The direct delivery of light to the photocatalyst also achieves a high energy efficiency for H₂O₂-production (2.3 kWh kg⁻¹ H₂O₂). The H₂O₂-production rate can be sustained for at least 5 repeated cycles (2 h per cycle).

In a first general aspect, a photocatalytic reactor includes a polymeric side-emitting optical fiber having a coating, wherein the coating includes a photocatalyst embedded in a porous polymer; a light source optically coupled to the polymeric side-emitting optical fiber and configured to irradiate the photocatalyst; and a multiplicity of oxygen-permeable hollow-fiber membranes. The polymeric side-emitting optical fiber and the multiplicity of oxygen-permeable hollow-fiber membranes are configured to be at least partially immersed in water. When at least partially immersed in water, the multiplicity of oxygen-permeable hollow-fiber membranes are configured to provide dissolved molecular oxygen to the water, and the coating is configured to allow diffusion of the dissolved molecular oxygen into the coating and to allow diffusion of hydrogen peroxide out of the coating.

In a second general aspect, making hydrogen peroxide includes at least partially immersing the polymeric side-emitting optical fiber and the multiplicity of oxygen-permeable hollow-fiber membranes of the photocatalytic reactor of the first general aspect in water; irradiating the photocatalyst with light through the polymeric side-emitting optical fiber; providing oxygen through the multiplicity of oxygen-permeable hollow-fiber membranes to the polymeric side-emitting optical fiber; and photocatalytically reducing the oxygen to yield hydrogen peroxide.

Implementations of the first and second general aspects may include one or more of the following features.

Examples of suitable light sources include concentrated solar light or a light emitting diode. The light can include visible light. The photocatalyst is configured to absorb radiation from the light source. The photocatalyst can be a metal organic framework photocatalyst. In one example, the metal organic framework photocatalyst includes iron. In some cases, the metal organic framework photocatalyst is a composite photocatalyst (e.g., carbon nitride doped with MIL-101(Fe)).

The photocatalytic reactor can include a first chamber configured to accept the side-emitting polymeric optical fiber and a second chamber configured to accept the multiplicity of oxygen-permeable hollow-fiber membranes. A conduit can be coupled to the first and second chambers and configured to allow oxygen-containing water to flow from the second chamber to the first chamber. The second chamber is typically configured to be coupled to a source of oxygen gas.

In some cases, the photocatalytic reactor further includes one or more additional polymeric side-emitting optical fibers, each optically coupled to the light source and including a coating including a photocatalyst embedded in a porous polymer. In certain cases, the photocatalytic reactor includes a first chamber configured to accept the polymeric side-emitting polymeric optical fibers and a second chamber configured to accept the multiplicity of oxygen-permeable hollow-fiber membranes. In other cases, the reactor includes a single chamber configured to accept the polymeric side-emitting polymeric optical fibers and the multiplicity of oxygen-permeable hollow-fiber membranes.

Providing oxygen through the multiplicity of oxygen-permeable hollow-fiber membranes to the polymeric side-emitting optical fiber can include diffusing the oxygen in the water, and circulating water from the multiplicity of oxygen-permeable hollow-fiber membranes to the polymeric side-emitting optical fiber(s).

The disclosed dual optical fiber-membrane photocatalytic system and methods advantageously improve energy efficiency and reduce hazards compared with conventional methods of H₂O₂ production. Platinum group or rare earth metal catalysts, organic precursor reactants (e.g., anthraquinones), and photocatalyst slurries are not required, which reduces the sustainability of the technology compared to producing hydrogen peroxide. Light is delivered in an energy efficient manner directly to the catalysts. Nearly 100% of oxygen is delivered in a usable dissolved form by the hollow-fiber membranes, and no oxygen bubbles are generated in or escape from solution. The metal organic framework photocatalysts used are compatible with the visible spectrum which expands their range of possible applications. Energy-efficient H₂O₂ production without chemical reactants makes the disclosed method a more sustainable option for producing H₂O₂.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic illustration of photocatalytic H₂O₂ production in a dual-fiber reactor, which combines one or more optical fibers coated with photocatalyst(s) and hollow-fiber gas-transfer membranes to deliver O₂ to the optical fiber(s).

FIG. 2 shows optical measurements of bare polymeric side-emitting optical fibers (POFs) and coated POFs. I_{S} and I_{U} performance of modified POF prepared by 7 g MIL-101(Fe) L⁻¹ slurries at 440 nm LED light (3 W) irradiation.

FIGS. 3A and 3B shows photocatalytic H₂O₂ generation followed the zero-order kinetics for H₂O₂ evolution and the evolution rates (the maximized H₂O₂ production rate obtained at 44 μgcm⁻² and prepared with a 7-g L⁻¹ slurry), respectively. Irradiation was 3 W with a 440-nm LED light.

FIG. 4A shows a zero-order-rate comparison with scavenger addition and no O₂ delivery in the dual-fiber system. FIG. 4B shows a photocatalytic H₂O₂ mechanism of the dual-fiber system with 440 nm LED light (3 W) irradiation.

### DETAILED DESCRIPTION

This disclosure relates to the integration of visible light emitting diodes, polymeric side-emitting optical fibers (POF), and O₂-delivering hollow-fiber membranes to enable low-energy and chemical-free photocatalytic production of hydrogen peroxide (H₂O₂). The POFs can be made of a variety of organic polymers, such as poly(methyl methacrylate). A variety of photocatalyst materials can be applied to the POF. In one example, a stable iron-basis metal organic framework photocatalyst (e.g., MIL-101(Fe)) that is activated by visible light is coupled to the surface of an optical fiber, resulting in a uniform and high-specific-surface-area (2,650 m² g⁻¹) coating on the optical fiber. Dissolved oxygen (O₂(aq)) is delivered into water through thin diameter bubble-free hollow fiber(s) fabricated of gas permeable membranes. The side-emitting optical fiber delivers light (UV-A or visible wavelengths) to a photocatalyst embedded in a porous cladding of the polymeric optical fiber. Photogenerated electrons and holes formed by irradiation of the photocatalyst react with oxygen and water, respectively, to yield hydrogen peroxide. With O₂ delivered from the hollow-fiber membranes and visible-light irradiation of the coated optical fiber, the H₂O₂-production rate in pure water was as high as 290 mM h⁻¹ catalyst-g⁻¹. The direct delivery of light to the photocatalyst achieved a high energy efficiency for H₂O₂-production (2.3 kWh kg⁻¹ of H₂O₂). The H₂O₂-production rate could be sustained for at least 5 repeated cycles (2 h per cycle).

Metal organic frameworks are self-assembled single-component crystal complexes with metal ions, organic ligands, and multiple binding sites (e.g., nitrogen or oxygen atoms). Metal organic frameworks can form two- or three-dimensional coordination structures. Compared with the other photocatalytic nanomaterials (e.g., TiO₂ or g-C₃N₄), metal organic framework photocatalysts can have higher surface area, larger pore volume, adjustable surface properties and are compatible with the visible spectrum of light. Suitable metal organic framework photocatalysts include MIL-101(Fe), MIL-88(Fe), and MIL-53(Fe). MIL-101(Fe) is advantageous because its band gap (2.57 eV) makes it effective in generating H₂O₂ from the reduction of O₂ (potential of 0.70 eV) using visible light.

The coated optical fibers are made by dispersing metal organic framework photocatalysts in a porous cladding that at least partially covers the exterior of polymeric optical fibers. The physical flexibility, light-source compatibility, and high photon-transfer efficiency of polymeric optical fibers make them suitable as optical sensors and light-harvesting nanolayers in the visible spectrum. A light source (e.g., light emitting diodes (LEDs), concentrated solar light), produces radiation tuned to wavelengths that excite the metal organic framework photocatalysts. The coated optical fiber delivers the radiation to the photocatalysts.

Hollow-fiber membranes are configured to deliver dissolved oxygen (O₂(aq)) to the coated optical fibers to make the hydrogen peroxide. While O₂(aq) may be generated from water oxidation during photocatalytic reactions, depletion of O₂(aq) slows H₂O₂ production. Although continuous bubbling of air through water can avoid O₂(aq) depletion, only a small fraction of the O₂ in air is transferred into water via bubbling systems, resulting in extra energy inputs for gas delivery compressors. In contrast, hollow-fiber membranes allow bubble-free O₂ delivery with approximately 100% delivery efficiency.

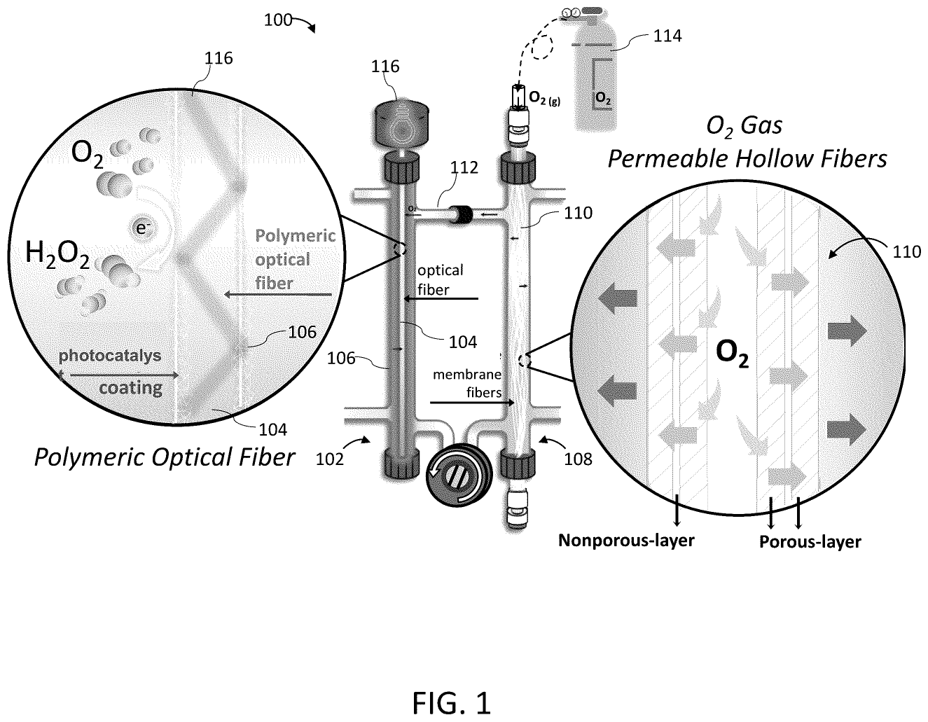

FIG. 1 illustrates a dual-fiber reactor 100. Dual-fiber reactor 100 includes chamber 102 with one or more POFs 104 with photocatalyst coating 106, and chamber 108 with a multiplicity of hollow-fiber membranes 110. Chambers 102 and 108 are in fluid communication through conduit 112. Oxygen source 114 is coupled to chamber 108, and provides O₂ to the multiplicity of hollow-fiber membranes 110. O₂ from hollow-fiber membranes 110 is provided to POFs 104 through conduit 112. Light source 116 is optically coupled to the one or more POFs 104. Structure, composition, and function of these components is disclosed herein.

While FIG. 1 depicts a single POF 104 in chamber 102, other embodiments of dual-fiber reactor 100 include two or more POFs 104 (e.g., a multiplicity of POFs 104) in chamber 102 with a single light source or multiple light sources. While FIG. 1 depicts chambers 102 and 108 as columns, other embodiments include chambers of various sizes, shapes, and materials. While FIG. 1 depicts chamber 102 and chamber 108 in fluid communication through conduit 122, other embodiments achieve fluid communication of the chambers through alternative arrangements. Other reactor configurations can include a multiplicity of POFs (e.g., bundled together) and coupled to one or more light sources in a single chamber together with one or more hollow-fiber gas permeable membranes or one or more multiplicities of hollow-fiber gas permeable membranes.

Light delivery to the photocatalysts is improved by enmeshing a photocatalyst (e.g., a metal organic framework) in a porous cladding on the exterior of POFs. Light emitting diodes (LEDs), tuned to wavelengths that excite the metal organic framework (MOF), produce light that the optical fiber delivers to the POFs. Optical fibers are common light waveguides for applications, such as photodetectors, lasers, and biosensors. Their physical flexibility, light-source compatibility, and high photon-transfer efficiency make POFs suitable as optical sensors and light-harvesting nanolayers in the visible spectrum. Coating photocatalysts on POFs offers advantages over catalytic slurries: quantifiable light utilization, short distances between the light source and catalytic interface, and inherent recovery and reuse of the catalysts.

MOFs are self-assembled single-component crystal complexes with metal ions, organic ligands, and multiple binding sites (N or O atoms). MOFs can form two- or three-dimensional coordination structures. Compared with the other photocatalytic nanomaterials (i.e., TiO₂ or g-C₃N₄), MOFs can have higher surface area, larger pore volume, and adjustable surface properties. The compatibility of MOFs with the visible spectra expand their applications.

Several types of MOFs—MIL-101, MIL-88, and MIL-53—have been used for gas storage, water splitting, and compound conversion. Among them, MIL-101(Fe) is attractive based on its band gap (2.57 eV), which makes it a good candidate to generate H₂O₂ from O₂ reduction (potential of 0.70 eV) using visible light.

Bubble-free delivery of dissolved oxygen (O_{2(aq)}) through hollow-fiber membranes (HFMs) facilitates catalytic H₂O₂ production. While O_{2(aq)} may be generated from water oxidation during photocatalytic reactions, depletion of O_{2(aq)} slows H₂O₂ production. Although continuous bubbling of air through water can avoid O_{2(aq)} depletion, only a small fraction of the O₂ in air is transferred into water via bubbling systems, resulting in extra energy inputs for gas delivery compressors. In contrast, hollow-fiber membranes (HFM) allow bubble-free O₂ delivery with ˜100% delivery efficiency.

Photocatalytic reactor embodiments described herein offer multiple benefits that improve energy efficiency and reduce hazards: no need for platinum group or rare earth metal catalysts or organic reactants (e.g., anthraquinones), direct delivery of light to the catalysts, and nearly 100%-efficient delivery and use of O_{2(g)}.

This disclosure describes fabrication of nanostructured MIL-101(Fe) with appropriate visible-light-response and high surface area on the POFs to enhance the light-utilization effects; quantification of photocatalytic H₂O₂ production and its energy consumption (kWh kg_{H2O2}⁻¹) in a dual-fiber system with the MIL-101(Fe) on POF and HFM; delineation of the mechanisms of H₂O₂ production in the photocatalytic process; and evaluation of the H₂O₂ production stability of dual-fiber systems.

In one example, visible-light-emitting diodes (41 mW cm⁻²), optical fibers, and O₂-delivering hollow-fiber membranes were integrated to enable low-energy and chemical-free photocatalytic production of H₂O₂. A stable iron-based metal-organic-framework photocatalyst (MIL-101(Fe)) activated by visible light was affixed to the optical fiber, resulting in a uniform and high-specific-surface-area (2,650 m² g⁻¹). The combination of optical-fiber-photocatalysts with O₂-permeable hollow-fiber membranes allows improved light utilization, photocatalyst reuse, and O₂ supply. The H₂O₂-production rate in pure water was as high as 290 mM h⁻¹ catalyst-g⁻¹. The efficient delivery of light also achieved a low energy cost for H₂O₂-production (2.3 kWh kg_{H2O2}⁻¹), and the H₂O₂-production rate could be sustained for at least 5 repeated cycles (2 h per cycle). Energy-efficient H₂O₂ production without chemical inputs makes the dual-fiber system a more sustainable option for H₂O₂ production.

### Examples

### Materials and Methods

### Fabrication of POF-MIL-101(Fe)

Poly(methyl methacrylate)-polymeric optical fiber (POF, CK-120, 3.0-mm diameter, reflective index of 1.49) was Eska™ High-Performance Plastic Optical Fiber obtained from Industrial Fiber Optics (AZ, USA). The POFs were composed of two materials: a poly (methyl methacrylate) core (PMMA, 3.0-mm diameter) with refractive index (n) of 1.49 and a fluorinated polymer as a cladding layer of 55-am thickness. Each POF was about 20-cm-long. Raw surfaces on both sides of a POF were polished using five optical polish films (LE30D, LE5P, LE3P, LE1P, and LE03P, Thorlabs, Newton, NJ) until a specular (mirror-like) surface was obtained. Polishing was followed by cutting the fibers with a blade and POF was coated with the MIL 101 (Fe) nanomaterials. The cut surfaces on both sides of bare and coated POFs had smooth, mirror-like surfaces, which reduced interference caused by an uneven surface as light from the LED was transmitted through the optical fiber.

MIL-101(Fe) on POF was fabricated by a dip-coating method using a photocatalyst slurry. A well-dispersed photocatalyst slurry with nanoparticle concentration from 1 to 10 g/L was produced by adding the desired weights of MIL-101(Fe) in 15 mL of isopropanol containing 20 wt % ionomers Nafion®; this mixture was sonicated for 1 hour in an ice bath. The POFs were dip-coated with the selected MIL-101(Fe) solution for two sec, followed by air drying for 5 min and rinsing with DI water and drying for 1 h at 60° C. The modified POFs were decorated with MIL-101(Fe) using multiple dip-coating into MIL-101(Fe) slurries in a concentration range between 0-10 g L⁻¹. Mass loadings (μg cm⁻²) of iron (Fe) ranged from 11 to 54 μg cm⁻². A single modified POF was placed into water, into which oxygen was delivered via a bundle (n=10) hollow-fiber gas permeable membranes.

### Fabrication of Hollow-Fiber-Membrane Bundle

Composite hollow-fiber membranes were purchased from Mitsubishi Rayon (Model MHF 200TL, Japan). Resins with low and high viscosity were obtained from Polymer Composites, Inc. (CA, USA). Masterflex® L/S® high-performance precision pump tubing (#MFLX06404-25 and MFLX 96412-15) was obtained from VWR (USA). Polyurethane tubing (Surethane NSF-51, ATP, USA) was used as the fiber-bundle adapter. A bundle was built using 32 hollow fiber membranes of ˜15-cm length. Low- and high-viscosity liquid resins were employed to encase the fiber bundle, and the potting method eliminated fiber pinching during the cutting. Prior to use in experiments, each bundle underwent a leak test and gas flow measurement (open end; 1393±22 cm³ min⁻¹; flow meter (Alicat, USA)) conducted using 10 psig (corresponding to 24.7 psia or 1.68 atm) N₂ gas by submerging fiber bundle in the DI water. Light utilization efficiency of POF-MIL-101(Fe)

Two key optical properties (i.e., light transmittance and refraction for light-side emission) of the POF and modified POF system were evaluated through photon irradiance. Pristine and photocatalysts-POF were mounted on monochromatic LEDs light (λ=440 nm, 3.0 W) set at ˜5.3 V and irradiance of 29 μW cm⁻². Light output irradiance (μW cm⁻²) was measured by a spectrophotoradiometer (Avantes AvaSpec-2048 L, Louisville, CO).

The total light input entering an optical fiber (I₀, μW cm⁻²) was distributed according to:

$${I}_{0} = {I}_{Abs} + {I}_{S} + {I}_{U} + {I}_{T} \qquad ( 1 )$$

where I₀ is the incident light entering the POF, I_{T} is the measured irradiance transmitted through the distal end of the POF, and I_{S} is the irradiance scattered by refraction through side-emission, which was recorded every 2 cm along the 20-cm fiber (Eq (2)), which is the integrated 3-dimensional (3-D) amount of energy side-emitted along the 20-cm length of the POF. I_{Abs} is calculated by Eq (3) with I₀ subtracting to I_{S} and I_{T} in uncoated POF (i.e., no nanomaterials coated) due to the I_{U} equals zero (%) in bare POF Eq (3). Finally, I_{U}, the light irradiance absorbed and utilized by the photocatalytic layer, was calculated by Eq (4) by subtracting the other values from I₀.

$${I}_{S} ( \% ) = \frac{{\int }_{0}^{L} {l}_{S} dL}{{I}_{0}} \times 100 \% \qquad ( 2 )$$

$${I}_{Abs ( bare PMMA POF )} ( \% ) = \frac{{I}_{0} - {I}_{T} - {I}_{S} - {I}_{U} ( 0 \% )}{{I}_{0}} \times 1 \; 00 \% \qquad ( 3 )$$

$${I}_{U} ( \% ) = \frac{{I}_{0} - {I}_{T} - {I}_{Abs} - {I}_{S}}{{I}_{0}} \times 100 \% \qquad ( 4 )$$

Configuration of the Dual-Fiber System for H₂O₂ Production.

Experiments to evaluate photocatalytic generation of H₂O₂ were conducted in a dual-fiber system (POF plus HFM), which was configured with two column reactors (e.g., 0.8 cm diameter; 18 cm tube length), each having 10-mL total volume. A 20-cm-long POF (i.e., 50.2 cm² of outer surface area) and a ˜20-cm-long HFM bundle were mounted in two parallel columns; the separate columns were connected by Masterflex tubing (MFLX06404-25). Compressed pure O_{2(aq)} was supplied at 2 psig (1.15 atm absolute) to the HFM, which corresponds to ˜40 O_{2(aq)} g m⁻² h⁻¹ delivery capacity. Ultrapure water (18.3 Ωcm, pH˜6.9) was purged with N₂ gas for at least 60 min to maintain its anoxic status before transferring it into the reactor. The water inside the dual-fiber system was circulated at a rate of 75 mL min⁻¹ with a peristaltic pump (Master Flex, model 7520-40, Cole-Parmer Instrument Company, U.S.A) to facilitate O_{2(aq)} reaching to POF. LED source (λ=440 nm, 3 W, Uxcell, China) was installed on the top of the POF. H₂O₂ production was measured by the assay described below and evaluated for different loadings of MIL-101(Fe) on the POF. A 10-μL solution sample was taken every 20 min, and most experiments lasted for 2 h; the robustness of the dual-fiber system was evaluated by repeating 5 successive photocatalytic experiments.

### Solid-State Characterization

The morphology and elemental distribution of pristine and modified POF surfaces were analyzed using a scanning electron microscope (SEM, JEOL JXA-8530F) coupled with energy dispersive X-ray diffraction (EDS) and transmission electron microscope at 120 kV. The crystallographic plane was assessed by X-ray diffraction (XRD) via Malvern PANalytical Aeris X-ray Diffractometer for POFs with Cu Kα radiation (λ=1.5406 Å) at a voltage of 40 kV and a current of 40 mA. X-ray photoelectron spectrometry (XPS) ESCA PHI 1600 using an AL dual anode of X-ray with a photon energy of 1486.6 eV was utilized to identify the chemical elements of POF-MIL-101(Fe). A Fourier Transform InfraRed (FTIR) spectrometer (Bruker, IFS66V/S) recorded chemical bonding in the wavenumber range of 700-4000 cm⁻¹ resolution. The absorption wavelength and valence band maximum (VBM) of MIL-101(Fe) were measured by a UV-visible spectrophotometer (U-4100 Hitachi) and ultraviolet photoelectron spectroscopy (UPS) with an ultra-violet He source. N₂ adsorption-desorption curves, specific surface area, and pore size distribution were obtained by Brunauer-Emmett-Teller specific surface area analyzer (BET, ASAP 2000). The Fe loading on the POFs were determined by inductively coupled plasma-mass spectrometer (ICP-MS, Perkin Elmer Inc., NexION 2000) followed by dissolving the POF-MIL-101(Fe) using the isopropanol (99% purity, Sigma-Aldrich).

H₂O₂ Measurement

H₂O₂ concentrations were quantified using a colorimetric method. A 10-μL aliquot was taken from the column reactor and transferred to the UV-Vis cuvette containing 2 mL HCl (50 mM), 0.2 mL ammonium molybdate (1 M), 0.2 mL KI (1 M), and 0.2 mL starch solution (1% in H₂O). The samples were incubated for 20 min after being well-mixed, and the absorbance was measured using a UV-Vis spectrophotometer (Cary 60, USA) at λ=570 nm. A calibration curve was built with concentrations of 0, 10, 25, 50, 100, 250, 500, 1000, and 3000 mg L⁻¹ of a certified H₂O₂ standard. Furthermore, the production kinetics of H₂O₂ concentration over time corresponded well to zero-order rates. Aqueous H₂O₂ production was verified by running UV-Vis absorbance spectra from 200 to 500 nm wavelength, which can be served as an independent validation of H₂O₂ concentrations based upon published molar absorptivity. All measurements were conducted in triplicate.

The energy consumption of photocatalytic H₂O₂ production (kWh kg_{H2O2}⁻¹) was computed from:

$$Energy consumption of {H}_{2} {O}_{2} ( kWh kgH 2 O {2}^{- 1} ) = \frac{1000 W \times t}{C \times V} \qquad ( 5 )$$

where C is the concentration of H₂O₂(mg L⁻¹), V is the volume (L), W is the energy of LED light (3 W), and t is the time (hour).

To decipher the mechanisms of H₂O₂ evolution, AgNO₃ and KI were used as scavengers for photogenerated electron (e⁻) and holes (h⁺), respectively, during H₂O₂-production experiments. The solutions were made up at 5 mM in 20 mL of ultrapure water.

### Results and Discussion

### Characterization of POF-MIL-101(Fe)

XRD measurements verified the crystalline structure of the Fe-based MOF. The pattern of MIL-101(Fe) displayed diffraction at 9.4°, 11.8°, 18.6°, and 23.7° 2θ, corresponding to the (311), (880), (511), and (852) crystal planes, respectively. The chemical compositions and element state of MIL-101(Fe) were investigated by XPS. A full-scan spectrum of MIL-101(Fe) was obtained: C 1s (284 eV), O 1s (531 eV), and Fe 2p (710 eV). The high-resolution C 1s spectrum can be separated into 3 peaks (284.5, 284.9, and 286.1 eV), which were assigned to C—C (sp³), C═C (sp²), and C—O bonds, respectively. Moreover, the deconvoluted O 1s peak was fit by 3 peaks located at binding energies of 530.3, 531.9, and 533.5 eV, which can be described to Fe—O, C—OH, and C—O—C (Figure S3c), respectively. Additionally, six peaks at the range of 710-733 eV were founded in the Fe 2p spectrum; the peaks at 711.0 and 724.1 eV can be attributed to Fe³⁺, and the peaks at 709.0 and 722.8 eV can be ascribed to Fe²⁺.

FTIR spectra of MIL-101(Fe) had absorption peaks at 750, 1020, 1390, 1582, 1702, 2850, and 3457 cm⁻¹. Peaks at 750 and 1020 cm⁻¹ signify the vibration band of aromatic C—H in the benzene ring and the C—O—C bond, respectively. The asymmetric vibration located at 1390 and 1582 cm⁻¹ correspond to the typical stretching mode of O—C═O. The absorption peak at 1702 cm⁻¹ is attributed to the stretching vibration of the carboxyl group. The asymmetric stretching vibration at 2850 cm⁻¹ is related to the C—H mode. Additionally, the intensive band at 3457 cm⁻¹ is assigned to the —OH groups. These FTIR spectra identify functional groups (e.g., C—H, C—O—C, O—C═O, C—H, carboxyl and —OH groups) on the surface MIL-101(Fe), illustrating that the polymerization reaction in the MOF synthesis successfully achieved the hybrid metal/organic nanostructure. Meanwhile, the crystallizations and chemical compositions in XRD and XPS validate the fabrication of MOFs and completely clarify the self-assembly between iron elements and organic linkers.

The optical properties and electronic-band structure of MIL-101(Fe) were measured by UV-visible spectroscopy. In the region of UV and visible wavelengths (300-600 nm), MIL-101(Fe) had a significant absorption response, but relatively low absorption was observed for 600-800 nm (Figure S4b). A band gap of 2.57 eV was calculated from the intercept of the tangents to the plots of A(hv)^{1/2} vs. photon energy. The calculated band gap illustrates that wavelengths smaller than 482 nm can photo-generate electrons (e⁻) and holes (h⁺). UPS analysis of the band structure of MIL-101(Fe) was used to determine the valence band maximum (VBM). The VBM of MIL-101(Fe) was estimated to be 1.99 eV. Based on the UV-visible spectra and VBM measurement, the conduction band (CB) of MIL-101(Fe) can be calculated as −0.58 eV. The narrow band gap of MIL-101(Fe) confirms the efficiency of visible-light-driven photocatalysis. The strong-reducing e⁻ on the CB and oxidizing h⁺ on the VB of MIL-101(Fe) are suitable for generation of H₂O₂ from O₂ (0.70 V) and H⁺ with O₂ from H₂O (1.23 V) via photocatalytic mechanism. Additionally, MIL-101(Fe) has a high specific surface area of 2,650 m² g⁻¹ and 2.0-nm micropores, which can increase the density of reactive sites to promote photogenerated e needed for photocatalytic H₂O₂ production from O₂.

The morphology and structure of pristine MIL-101(Fe) and POF-MIL-101(Fe) were characterized by SEM and EDS. MIL-101(Fe) had a regular octahedral nanostructure with uniform particle size (i.e., diameter=400±50 nm). Electron-microscope images with elemental distributions for the exterior surface of uncoated POF and POF-MIL-101(Fe) were obtained. The surface of bare POF contained 0 and F elements, since the PMMA polymer and a fluorinated cladding layer comprised the POF. The cladding of the POF-MIL-101(Fe) was homogenous, as indicated by the uniform coverage of iron. Overall, the POF-MIL-101(Fe) was successfully fabricated by the dip-coating process.

### Light Efficiency for Utilization, Scattering, and Transmittance

Compared with bare POF, integration of MIL-101(Fe) into the POF cladding increased side-emitted light intensity, thus facilitating photocatalytic reactions. The bare POF side-emitted light at 440 nm was due to the refractive index of the PMMA core (n=1.49), although the side-emission was of relatively low intensity along the 20-cm length (e.g., 1,060 μW cm⁻² at the proximal end and 80 μW cm⁻² at the distal end). The side emissions increased, to 1830 μW cm⁻² at the proximal end, with a thin nanomaterial layer of MIL-101(Fe) (11 μg cm⁻²) on the POF. This increase can be attributed to a change in the reflective index after MIL-101(Fe) coating, additional scattering interface provided by the MIL-101(Fe) coating, and interaction with the evanescent wave (e.g., an electromagnetic wave generated at the side of the optically sparse medium) by the MIL-101(Fe) photocatalysts. The MIL-101(Fe) mass loading of 39 μg cm⁻² had the highest side-emitted light intensity, with 6,800 μW cm⁻² at the proximal end, which asymptotically reached 520 W cm⁻² at the distal end.

I_{S} efficiency (%) was shown to depend on the mass loading of MIL-101(Fe): I_{S} (%) initially increased, up to 32% or 7.8-fold higher than the value of bare POF, when 39 μg cm⁻² of MIL-101(Fe) was coated on the POF (i.e., 7 g MIL-101(Fe) L⁻¹). However, I_{S} (%) declined when the mass loading of MIL-101(Fe) was increased up to 51 μg cm⁻². Increasing the mass loading by 1.3-fold, from 39 to 51 μg cm⁻², led to “excess” catalyst deposition on the POF, which caused aggregation that obstructed the scattered light. In summary, the photocatalytic layer improved side-emission, which increased light interactions with the deposited nanomaterials.

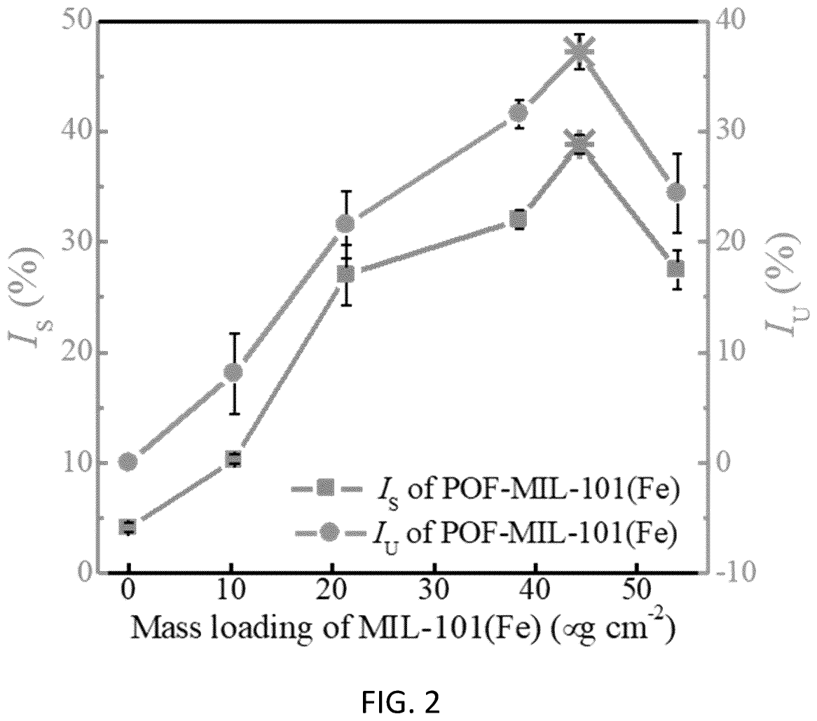

Multiple coatings of optimized coating density slurry (7 g MIL-101(Fe) L⁻¹) were evaluated. FIG. 2 shows that the highest I_{S} was achieved with 4 coating cycles (44 μg cm⁻²). While I_{S} (%) increased from 10% (single coating) to 39% (4-cycle coating), it declined to 28% with 5 coating cycles. When I_{U} (%) was calculated by Eq (4), FIG. 2 shows that I_{U} (%) was highest at 37%, with a mass loading of MIL-101(Fe) of 44 μg cm⁻². I_{S} and I_{U} data demonstrate that an optimal mass loading maximizes side emission and increases energy utilization by the photocatalysts. Thus, the I_{S} and I_{U} results followed a similar trend, showing that “excessive” photocatalyst compromised I_{S} and I_{U}. Because 4-cycle coating achieved the highest I_{S} and I_{U}, it was selected for the following studies.

H₂O₂-Generation Activity

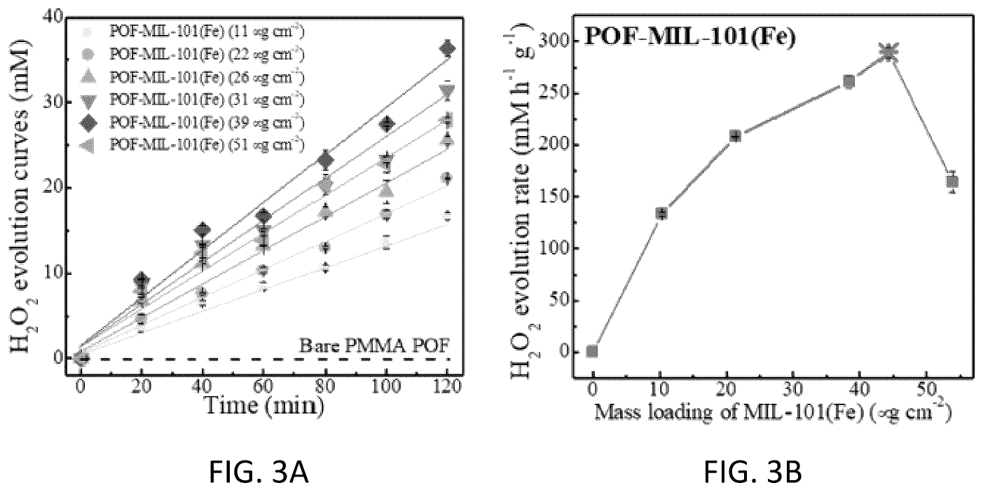

The dual-fiber system (FIG. 1A) was evaluated for H₂O₂ generation. FIG. 3A shows that photocatalytic H₂O₂ production corresponded to zero-order kinetics; the zero-order rate coefficient (k, M s⁻¹) and the rates of H₂O₂ generation (mM h⁻¹ g⁻¹) depended on the loading of MIL-101(Fe). H₂O₂-production increased linearly with iron mass loading: H₂O₂ production rates for 11 to 39 μg cm⁻² mass loading of POF-MIL-101(Fe) were 140 to 260 mM h⁻¹ g⁻¹, correspondingly. As expected, a still-higher photocatalyst loading, 51 μg cm⁻², led to a slower H₂O₂-production rate (216 mM h⁻¹ g⁻¹). FIG. 3B shows that 4-cycle coating reached a rate up to 290 mM h⁻¹ g⁻¹ (e.g., 1237 mg L⁻¹), which was 1.8-fold greater than with the mass loading with 54 μg cm⁻² (160 mM h⁻¹ g⁻¹) and 3.5-fold higher than with a photocatalytic MIL-101(Fe) slurry reaction within the same conditions (e.g., 10 mg catalysts; 84 mM h⁻¹ g⁻¹ of production rate). Energy consumption (from Eq. 5) was 2.3 kWh kg_{H2O2}⁻¹ for the optimal conditions, a value 63-fold lower than reported values for slurry photocatalysis using aa 500 W Xe lamp. Thus, POF-MIL-101(Fe) with 44 μg cm⁻² mass loading maximized the H₂O₂-production rate and minimized energy consumption in the dual-fiber system.

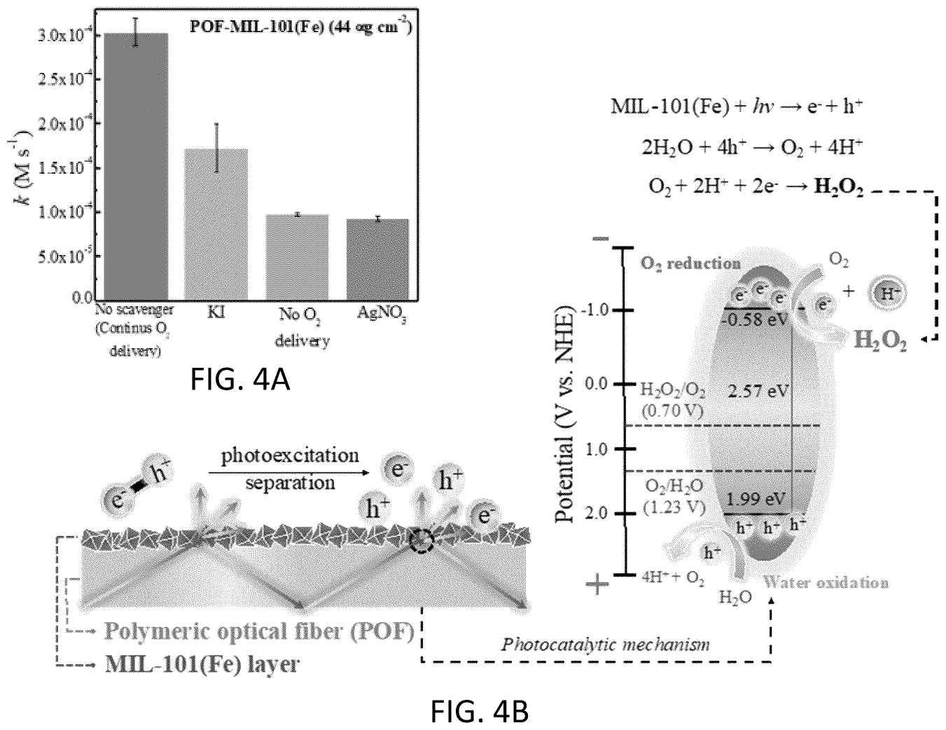

To validate the H₂O₂-production mechanisms, experiments were conducted in the presence of e⁻ and h⁺ scavengers, AgNO₃ and KI, respectively, as well as without an O₂(g) supply. FIG. 4A shows that the rate constant (k=3.0×10⁻⁴ M s⁻¹ with no scavengers) in the dual-fiber system declined 3.2- and 1.7-fold in the presence of AgNO₃ and KI, respectively. The H₂O₂-generation rate was strongly limited by the loss of photogenerated e⁻ (by AgNO₃) or h⁺ (by KI), and the impact was greater for loss of e⁻. Hence, the production of H₂O₂ from O₂ reduction by e⁻ was more critical than water oxidation by h⁺, but both reactions occurred. Eliminating the continuous O₂ supply via the HFMs also reduced the H₂O₂-production rate, further supporting that the H₂O-oxidation reaction via h⁺ contributed to H₂O₂ evolution.

The H₂-reduction reaction (i.e., H⁺+2e⁻→H₂) also can occur. The H₂ evolution rate had a small rate constant, k=6.0×10⁻⁶ M s⁻¹ that was obtained with identical conditions (photocatalytic POF-MIL-101(Fe), 44 μg cm⁻²) as H₂O₂ production. The H₂-evolution rate, 0.12 mmol H₂ h⁻¹ catalyst g⁻¹, was far lower than the rate of O₂ reduction for H₂O₂ production, 10.4 mmol H₂O₂ h⁻¹ catalyst-g⁻¹.

FIG. 4B schematically illustrates the mechanisms for photocatalytic H₂O₂ production on the surface of POF-MIL-101(Fe). Visible light irradiation photogenerated e⁻ and h⁺, respectively, on the CB and VB of MIL-101(Fe). H₂O was oxidized by h⁺ (potential of 1.23 V (O₂/H₂O)) to release H⁺ ions and O₂ on the photocatalyst surface. Then, O₂ molecules interacted with e⁻ and H⁺ to produce H₂O₂ by O₂ reduction (potential of 0.70 V (H₂O₂/O₂)).

To demonstrate the stability of modified POF-MIL-101(Fe) (44 μg cm⁻²) for photocatalytic H₂O₂ generation, the robustness of the dual-fiber system was evaluated by 5 successive photocatalytic experiments. A relatively linear trend was seen for the five repeated cycles of H₂O₂ production (2-h duration per cycle), while the production rates of the second to fifth cycles, when compared with the first cycle, were not statistically different (p-value >0.05, paired samples test). In parallel with the stable H₂O₂ performance, SEM images also show that the exterior surface of POF-MIL-101(Fe) retained its uniform element distribution after five repeated cycles, indicating that the modified POF has exceptional robustness to expose to the elevated H₂O₂ concentrations in a dual-fiber system.

Although numerous nanostructured photocatalysts were able to produce H₂O₂ with visible-light irradiation: carbon nitride, an inorganic composite, and MOFs. None of the photocatalytic slurries could achieve a production rate >200 mM h⁻¹ g⁻¹, although a few production rates exceeded 100 mM h⁻¹ g⁻¹ when O₂ was supplied in the continuous mode. Thus, the H₂O₂-production rate of the dual-fiber system (290 mM h⁻¹ g⁻¹) was much higher than in any other system.

The POF design also achieved its high H₂O₂-production rate with the lowest energy consumption ratio: 2.3 kWh kg_{H2O2}¹, which was 14- to 53-fold lower than the other systems. This demonstrates that the POF architecture can more efficiently utilize light energy, at least because a POF decorated with nanocrystal MIL-101(Fe) strengthens the interaction between light irradiation and the photocatalyst.

Although a single POF reactor is described, other embodiments include multiple POFs (e.g., a bundle of POFs). Also, although a single visible-light-response nanomaterial susceptible to electron-hole recombination is described, a nanocomposite photocatalyst with different heterostructures, such as type II, Z-scheme, and P-N junction, can be used to mitigate the electron-hole recombination to achieve the efficient redox reaction while also decreasing recombination. Moreover, a composite material can expand the absorption wavelength in a visible light spectrum and, hence, increase the light utilization efficiency for higher H₂O₂.

MIL-101(Fe), synthesized via a hydrothermal method, was uniformly deposited onto the surface of polymeric optical fibers. The 400-nm MIL-101(Fe) had high surface area (2,650 m² g⁻¹), exhibited a homogenously crystalline nanostructure, and dramatically enhanced photocatalytic H₂O₂ generation using visible light. When applied in a dual-fiber configuration, the rate of photocatalytic H₂O₂ production was as high as 290 mM h⁻¹ g⁻¹ with energy consumption from LED light of only 2.3 kWh kg_{H2O2}⁻¹. Compared to published results for H₂O₂ production from photocatalysts, the results with the dual-fiber system are 2- to 60-fold higher H₂O₂ production rates and 14- to 53-fold lower energy consumption. A stability evaluation of POF-MIL-101(Fe) also showed that H₂O₂-production rates could be sustained over 5 cycles (2-h per each cycle) at >95% of the original H₂O₂-production rate. The simple-and-efficient features of the dual-fiber system offer advantages for mass production of H₂O₂ and in-situ disinfection or oxidative remediation.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A photocatalytic reactor comprising:
a polymeric side-emitting optical fiber comprising a coating, wherein the coating comprises a photocatalyst embedded in a porous polymer;
a light source optically coupled to the polymeric side-emitting optical fiber and configured to irradiate the photocatalyst; and
a multiplicity of oxygen-permeable hollow-fiber membranes,
wherein the polymeric side-emitting optical fiber and the multiplicity of oxygen-permeable hollow-fiber membranes are configured to be at least partially immersed in water, and when at least partially immersed in water, the multiplicity of oxygen-permeable hollow-fiber membranes are configured to provide dissolved molecular oxygen to the water, and the coating is configured to allow diffusion of the dissolved molecular oxygen into the coating and to allow diffusion of hydrogen peroxide out of the coating.

2. The photocatalytic reactor of claim 1, wherein the light source comprises concentrated solar light or a light emitting diode.

3. The photocatalytic reactor of claim 1, wherein the photocatalyst is configured to absorb radiation from the light source.

4. The photocatalytic reactor of claim 1, wherein the photocatalyst comprises a metal organic framework photocatalyst.

5. The photocatalytic reactor of claim 4, wherein the metal organic framework photocatalyst comprises iron.

6. The photocatalytic reactor of claim 4, wherein the metal organic framework photocatalyst comprises a composite photocatalyst.

7. The photocatalytic reactor of claim 6, wherein the metal organic framework photocatalyst comprises carbon nitride doped with MIL-101(Fe)).

8. The photocatalytic reactor of claim 1, wherein the reactor comprises a first chamber configured to accept the side-emitting polymeric optical fiber and a second chamber configured to accept the multiplicity of oxygen-permeable hollow-fiber membranes.

9. The photocatalytic reactor of claim 8, further comprising a conduit coupled to the first and second chambers and configured to allow oxygen-containing water to flow from the second chamber to the first chamber.

10. The photocatalytic reactor of claim 9, wherein the second chamber is configured to be coupled to a source of oxygen gas.

11. The photocatalytic reactor of claim 1, further comprising one or more additional polymeric side-emitting optical fibers, each optically coupled to the light source and comprising a coating comprising a photocatalyst embedded in a porous polymer.

12. The photocatalytic reactor of claim 11, wherein the reactor comprises a first chamber configured to accept the polymeric side-emitting polymeric optical fibers and a second chamber configured to accept the multiplicity of oxygen-permeable hollow-fiber membranes.

13. The photocatalytic reactor of claim 11, wherein the reactor comprises a single chamber configured to accept the polymeric side-emitting polymeric optical fibers and the multiplicity of oxygen-permeable hollow-fiber membranes.

14. A method of making hydrogen peroxide, the method comprising:
at least partially immersing the polymeric side-emitting optical fiber and the multiplicity of oxygen-permeable hollow-fiber membranes of the photocatalytic reactor of claim 1 in water;
irradiating the photocatalyst with light through the polymeric side-emitting optical fiber;
providing oxygen through the multiplicity of oxygen-permeable hollow-fiber membranes to the of polymeric side-emitting optical fiber; and
photocatalytically reducing the oxygen to yield hydrogen peroxide.

15. The method of claim 14, wherein the light comprises visible light.

16. The method of claim 14, wherein the photocatalyst comprises a metal organic framework photocatalyst.

17. The method of claim 16, wherein the metal organic framework photocatalyst comprises iron.

18. The method of claim 14, wherein providing oxygen through the multiplicity of oxygen-permeable hollow-fiber membranes to the polymeric side-emitting optical fiber comprises diffusing the oxygen in the water.

19. The method of claim 14, further comprising circulating water from the multiplicity of oxygen-permeable hollow-fiber membranes to the polymeric side-emitting optical fiber.

20. The method of claim 14, wherein the photocatalytic reactor further comprises one or more additional polymeric side-emitting optical fibers.
